(19) United States
(12) Patent Application Publication
(10) Pub. No.: US 2009/0262458 A1
(43) Pub. Date: Oct. 22, 2009

(54) ABS design for dynamic flying height (DFH) applications

(75) Inventors: Xinjiang Shen, Fremont, CA (US); Zhu Feng, Pleasanton, CA (US); Ellis Cha, San Ramon, CA (US); Robert Chu, San Jose, CA (US)

Correspondence Address: SAILE ACKERMAN LLC, 28 DAVIS AVENUE, POUGHKEEPSIE, NY, 12603, US

(73) Assignee: SAE Magnetics (HK) Ltd.

(21) Appl. No.: 12/148,602

(22) Filed: Apr. 21, 2008

(51) Int. Cl. G11B 5/60

(52) U.S. Cl. 360/234.3

(57) ABSTRACT

A DFH (Dynamic Flying Height) type slider ABS design has significantly improved DFH efficiency and a decreased sensitivity of flying height to both ambient conditions and disk surface variations. This is a result of embedding the read/write head and heater in a micro-pad having a very small surface area. The micro-pad is surrounded by a wing-like structure that projects from a central rail in the ABS. The micro-pad is separated from the central rail by a surrounding trench whose depth can be varied to tune the DFH efficiency. The small surface area of the micro-pad reduces the air pressure at the read/write head and the projecting wings and adjacent topology help to direct the airflow around the micro-pad.

### BACKGROUND OF THE INVENTION

1. Field of the Invention

This invention relates to the fabrication of thin film magnetic read/write heads and particularly to a method for forming a DFH (Dynamic Flying Height) slider surface to achieve high DFH efficiency, stable aerodynamics and minimum variations of flying height under a wide range of conditions.

2. Description of the Related Art

As shown in schematic FIG. 1, (taken substantially from Meyer et al., (U.S. Pat. No. 5,991,113)) a hard disk drive (HDD) uses an encapsulated, small thin film magnetic read/write head (52), formed within a ceramic substrate to read and write data on a magnetic medium or storage disk (20). The read/write head is formed using well known semiconductor deposition techniques such as electroplating, CVD (chemical vapor deposition) and photolithographic patterning and etching. The entire structure of head plus substrate is called a slider (7).

The slider (7) has a pre-patterned air-bearing surface (ABS) plane (300) that faces the rotating disk (20) during HDD operation. Although the ABS plane is substantially planar, as we shall see, it has a patterned topography which extends into the body of the slider vertically away from the surface plane. The slider is mounted (26) on the distal end of a head gimbal assembly (HGA) (22) that is activated by an electro-mechanical mechanism and control circuitry to position the head at various positions along the magnetic tracks on the disk (not shown).

As the disk is rapidly rotated by a spindle motor (not shown), hydrodynamic pressure causes an air flow (arrow (25)) between the ABS of the slider and the surface of the disk. This flow lifts the slider so that it literally flies above the surface of the disk on a layer of air. The spacing between the head and the disk surface at this position is referred to as the “flying height.” (80). The edge of the slider into which the disk rotates (the rotation also indicated by the airflow arrow) is called its “leading edge” (40), the opposite edge, which contains the read/write head (52), is called the “trailing edge” (44). The read/write head is encapsulated within the slider at its trailing edge and, as we shall see below, in the “dynamic flying height” (DFH) type slider, the read/write head is also surrounded by, or adjacent to, embedded heating elements (60). The slider topography also includes airflow grooves (not shown in this view) that are etched into the slider surface to provide an enhanced aerodynamic performance. The embedded heating elements (60) can be activated by external circuitry (58). The aerodynamics of the slider motion lifts the leading edge higher above the rotating disk surface than the trailing edge.

For a typical disk drive (approx. 250 Gbyte/platter) the flying height distance (80) between the magnetic head and the media is between approximately 5-6 nm (nanometers). It is essential that the sliders fly with aerodynamic stability over the disk surfaces during reading and writing. There are currently two types of disk drive designs: (a) Load/Unload (LUL) design and (b) Contact Start Stop (CSS) design. In the LUL design the sliders stay on a ramp that is outside the perimeter of the magnetic disk when no reading or writing is underway. In the CSS design the sliders park on the disk at the innermost radius (landing zone) of the disk when no reading or writing is underway. Compared to the LUL design, the CSS design has to overcome the stiction/adhesion between sliders and disk when the sliders first take off at the initial stage of flying above the disk surface. One of the effective ways of minimizing this stiction/adhesion at the slider/disk interface is to lower the real contact area. This is presently achieved by two approaches: (a) roughening the disk surface at the CSS zone by either using mechanical or laser texturing, or (b) adding pads on the slider surface, preferably at the trailing edge of the surface. The stiction consideration for CSS drives with padded sliders requires that the flying pitch of the slider has to be above a certain value so that there is no contact between the pad and disk surface at high altitudes. Because of this consideration the sliders for CSS drives usually have a high flying pitch (>150 micro-radians).

Currently, the distance between the slider and the media has been pushed to as low as 5 nm during read processes via one technology called dynamic flying height (DFH). This technology is described, for example, in Meyer et al, (U.S. Pat. No. 5,991,113) and illustrated in FIG. 1. This technology achieves local flying height reduction by applying a voltage to a heater ((60) in FIG. 1) embedded in the slider body. Referring again to FIG. 1, a schematic indication of a heater (60) is shown as being positioned close to the read/write head (52). Heat supplied by the heater increases the temperature of the slider in the heater's vicinity and this increase in temperature, in turn, causes the surface of the slider to protrude as a result of thermal expansion of the surrounding material. In principle, this protrusion will bring the read/write head closer to the disk surface, thus reducing the flying height and allowing for greater resolution in the read/write process.

During the resulting temperature induced protrusion process, however, the slider will be pushed back by the protrusion-induced increased air pressure acting on the slider due to the squeezed layer of air within the head/disk interface. This additional air pressure acts counter to the desired flying height reduction that the heater-induced slider protrusion is meant to produce. Thus it is highly desirable to produce a method of decreasing flying height by a thermal process, while not allowing that very decrease to counter the desired effect.

In DFH technology, the heater is turned on only when a read or write operation is called for. This substantially improves the reliability of the head/disk interaction for the following reasons: 1) the magnetic head does not have to constantly fly at low flying heights; 2) the magnitude of flying height reduction can be made to depend on the environmental conditions, for example a smaller height reduction is required at high temperatures and high altitudes; 3) the flying height minimum point is always at the heater area, the other areas of potential contact are always higher and, therefore, the opportunities for contact are reduced; 4) even if there is a contact at the heater area, the contact force is smaller due to the reduced area of contact and, therefore, there is less chance of creating head modulation and related read/write failure.

The various processes cited above have created the following meaningful challenges for slider design in DFH applications. The following two challenges are associated with the design of the air bearing surface.

### A. Very High Pressure is Applied on the Heated Area of the Slider.

This produces what is called “pushback” or ABS (air-bearing surface) compensation, which is the counterproductive effect of preventing the local deformations of the slider body that are required to produce good DFH efficiency. The DFH efficiency is defined as the ratio of the actual flying height reduction to the slider body protrusion height (or, equivalently, to heater power). If the protrusion produced by a given input of heater power is negated by the added pressure pushing the slider away from the disk surface, then the effects have canceled each other and more heater power is required to accomplish a given flying height reduction. One approach to mitigating this problem is, therefore, to simply apply higher power to the heater. Unfortunately, over long term operation this can either degrade the reader performance or cause excessive power consumption or both. Alternatively, to further improve the DFH efficiency of air bearing sliders for DFH applications, traditional designs attempt to reduce the pressure acting on the entire slider body. This approach sacrifices the flying height sigma, i.e., the tight control over statistical variations in flying height for a set of sliders.

### B. Large Disk Distortion at the Inner Radius.

Disks usually have large distortions under disk clamping forces. This produces an undulating disk surface and a large flying height variation between the slider and the disk across the disk surface. This distortion is more pronounced at the inner diameter (ID) than the outer diameter (OD). This creates yet another challenge to achieving a stable flying height across the entire disk surface. Lowering the pressure at the area where the magnetic sensor is carried will significantly increase the sensitivity to local disk distortions at the inner radius.

The following challenges are a result of the specific requirements of consumer electronics.

### A. Temperature Requirements.

Consumer electronics devices are required to operate within the large range of temperatures between −20° C. and +80° C. The flying height between the magnetic head and the media surfaces can change due to mechanical changes in the system resulting from the temperature variations. For example, the static pitch altitude (PSA) of the head gimbal assembly (HGA) can change and, additionally, the temperature variations can create changes in the shape of the slider crown. It is therefore desirable that an ABS design can be able to compensate for flying height changes due to changes in the slider shape.

### B. Altitude Requirement.

Consumer electronics devices are usually required to operate at an altitude of 10,000 ft. Since the air density at such an altitude is much lower than that at sea level, the high altitude has a direct impact on the flying height between the magnetic head and the media. It is therefore desirable to have a slider ABS design that minimizes the flying height changes due to high altitude.

### C. Power Requirements.

Consumer electronics devices also have a limitation on the amount of power that can be used during drive operations. Higher DFH efficiency will reduce the power necessary to achieve the necessary flying height to read and write.

Different approaches have been suggested for achieving higher DFH efficiency. One approach is via ABS design. Hashimoto et al., U.S. Patent Application 2007/0058296 and U.S. Patent Application 2006/0139810 describes an isolated ABS pad for achieving flying height control by DFH. The operation of the pad is to reduce the push back effect caused by protrusion by moving the pressure peak on the ABS from the pad itself to a position on the ABS surrounding the pad. Since the ABS pressure at such an isolated pad is small, a large deformation/protrusion can be achieved at low heater power, thereby producing a high DFH efficiency. However, too high a DFH efficiency is not always desirable for two reasons: 1) an incompatibility with the DFH pre-amplifier which causes poor control of the protrusion due to low pre-amplifier resolution; 2) potential reliability concerns on weak air pressure at the isolated pad. Therefore, this slider design does not effectively control DFH efficiency while maintaining aerodynamic stability.

An alternative, though somewhat similar approach was previously presented by the Data Storage Institute (DSI) in Singapore. They proposed a separated pad feature to provide a high DFH efficiency. However, this prior art from DSI is associated with a very high flying height modulation during HDD operation due to the limitations of the design, because the separated pad is not supported by the surrounding ABS. Thus, any disk distortion will cause severe change in flying height. In view of these reliability issues associated with current state of the art devices, the present invention proposes new ABS designs for doubling the DFH efficiency of a slider while maintaining a stable flying height.

Other prior art approaches are to found in the following patents.

U.S. Pat. No. 5,761,003 (Sato) an ABS slider configuration including a pressure generating section to provide stable lifting force to the slider.
U.S. Patent Application 2007/0230021 (Schreck et al) eliminates flying height transient changes during transitions from read to write or write to read by using a fly height controller to cancel the net transient change by controlling the heating element.
U.S. Patent Application 2006/0082917 (Yao et al) describes a fly height controller comprising a piezoelectric piece under the slider.
U.S. Patent Application 2002/0024774 (Berger et al) teaches adjusting flying height by a controlled variation of the spring constant of the suspension arm.

It is the view of the present inventors that none of the aforementioned approaches will achieve the stable and controllable DFH slider dynamics and improved DFH efficiency of the present invention as defined by the following objects and method of achieving them.

### SUMMARY OF THE INVENTION

It is a first object of this invention to improve the DFH efficiency of a slider.
It is a second object of this invention to improve the DFH efficiency of a slider while maintaining its aerodynamic stability.
It is a third object of this invention to maintain the aerodynamic stability of a DFH slider over a wide range of conditions imposed upon it due to the requirements of consumer electronics such a altitude ranges, power consumption and temperature changes.
It is a fourth object of this invention to minimize sensitivity of the flying height of the DFH slider to surface variations of a rotating disk.
It is a fifth object of this invention to provide a slider having very high DFH efficiency and one whose DFH efficiency can be tuned.

These objects will be met by a new ABS design that is schematically illustrated in both FIG. 2, as a partial 3-D view and FIG. 3 in a more detailed plane view. Referring first to FIG. 3, showing a first embodiment, the design includes a separated leading ABS structure (250), shown partially, and a trailing ABS structure (150). Here, to avoid confusion, we will refer to that part of the ABS structure that includes the slider's leading edge (200), as the leading ABS structure and we will refer to that part of the ABS structure that includes the trailing edge (not shown) as the trailing ABS structure. Note that FIG. 2 shows only a 3-D schematic illustration of trailing ABS structure shown as (150) in FIG. 3). As is shown in both FIG. 2 and FIG. 3, the trailing ABS structure includes two side rails (325), a pair of airflow channels (320) and a central rail (350). The trailing ABS structure also includes a micro-pad (310) of very small surface area that contains the read/write head (shown in FIG. 3 as (30)) and an embedded DFH heater (not shown in either FIG. 2 or FIG. 3). The micro-pad is at the extreme trailing edge (shown as arrow (100) in FIG. 3) of the trailing structure. The micro-pad is substantially surrounded laterally by a structure that projects outward (i.e., in a direction towards the trailing edge of the slider) from the central rail (350) as two wings (355). These two wings are part of the trailing edge ABS structure. The micro-pad is physically separated from this wing structure by a trench (labeled in FIG. 3 as (360)). The wings create a concavity in the trailing edge perimeter of the central rail and the micro-pad resides in this concavity while being physically separated from the rail itself by the trench. This separated micro-pad reduces the pressure acting on the slider DFH heated area significantly, which provides a very high measured DFH efficiency. The surrounding wing structure provides a very stable aerodynamics and flying height during operation. The role of the micro-pad is to separate the DFH heater-containing magnetic sensor area (i.e., the read/write head) of the slider from the rest of the trailing ABS structure. This separation prevents the buildup of air pressure on the sensor portion of the slider because that portion no longer provides sufficient pressure length for the buildup to occur. The air pressure at the sensor area depends on the incoming airflow and, particularly, on the distance the air travels against the sensor area (i.e., the pressure length). The shape of the leading portion of the ABS structure (shown only in FIG. 3 as (250)), the airflow channels (320) and the patterning of the central rail (350) that is to the leading edge side of the micro-pad also divides the airflow and limits the air flowing through the micro pad.

In a second embodiment, it is shown that by varying the depth of the trench (360) that surrounds the micro-pad and separates it from the wing structure, a very sensitive control of the amount of heater-produced protrusion of the sensor can be obtained. Thus the trench, through the ability to adjust its depth, emerges as a determinant of ABS dynamics that can be utilized to tune the performance of the slider.

### BRIEF DESCRIPTION OF THE DRAWINGS

The objects, features, and advantages of the present invention are understood within the context of the Description of the Preferred Embodiment as set forth below. The Description of the Preferred Embodiment is understood within the context of the accompanying figures, wherein:

FIG. 1 is a schematic illustration of a prior art DFH slider mounted read/write head in operation within a hard disk drive (HDD).

FIG. 2 is a schematic 3-D illustration of a trailing edge portion of the present slider designed to provide DFH control by use of a separate micro-pad for holding the read/write head.

FIG. 3 is a schematic planar illustration of an air bearing surface (ABS) structure of either embodiment of the present invention.

FIG. 4 is a graphical representation showing the change in fly height as a function of heater power for a variety of prior art DFH design sliders.

FIG. 5 is a graphical representation showing the change in fly height as a function of heater power for several sample sliders of the present invention design.

FIG. 6 is a schematic side view of the slider of the second embodiment showing the trench depth and the micro-pad.

FIG. 7 is a graphical illustration showing controlled protrusion height as a function of trench depth for the second embodiment of this invention.

FIG. 8 is a graphical illustration showing the measured protrusion profile across the micro-pad with a controlled trench depth for the second embodiment of this invention.

### DESCRIPTION OF THE PREFERRED EMBODIMENTS

### First Preferred Embodiment

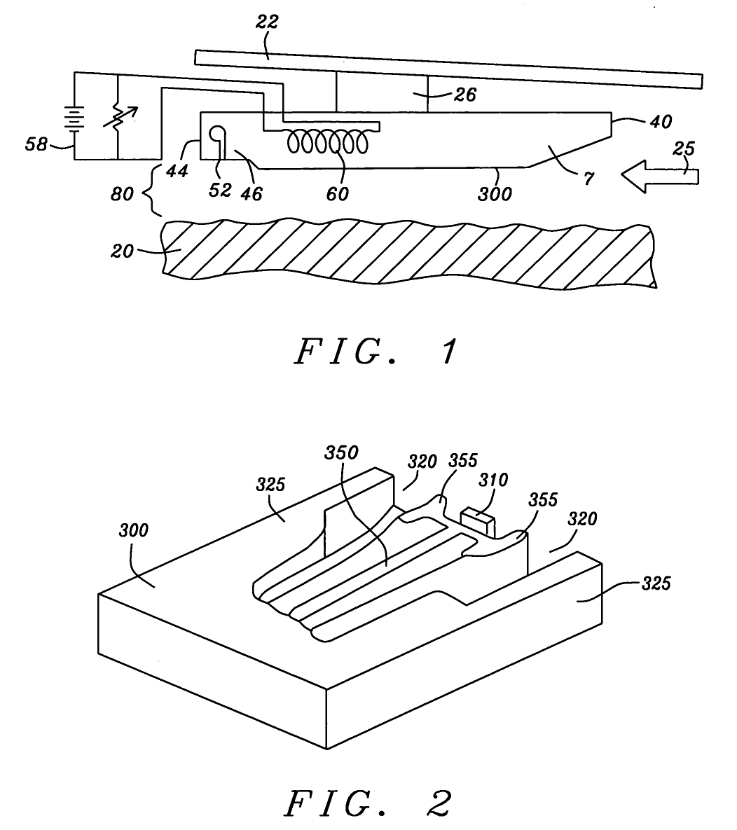

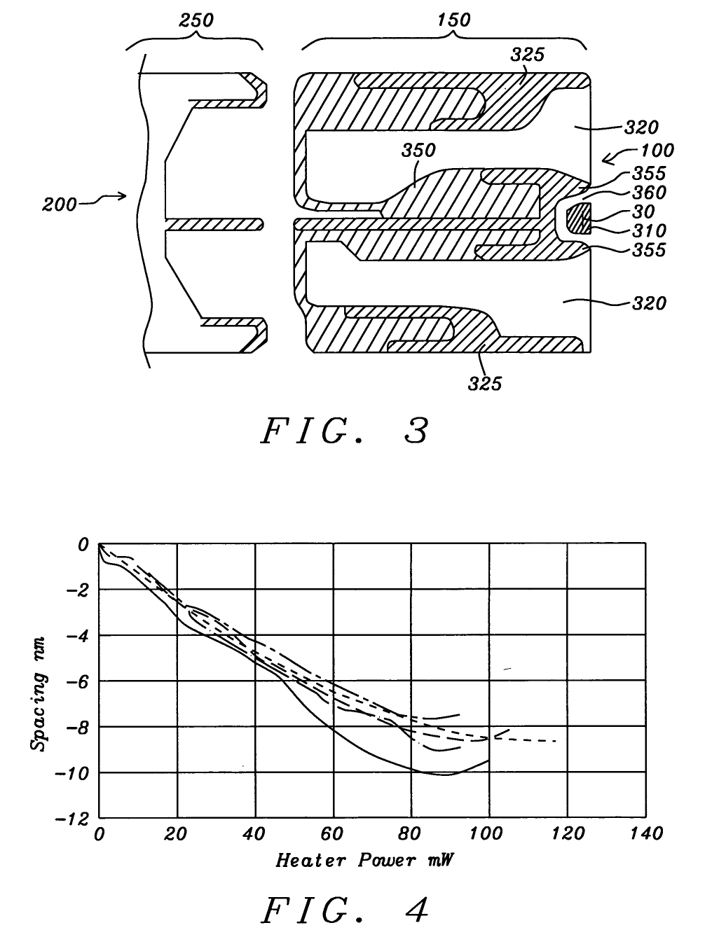

Referring to FIG. 3, there is shown a schematic drawing of a plane view of the ABS of the slider of a first embodiment of the present invention from a perspective obtained by looking up at the ABS from an adjacent disk surface. Referring to FIG. 2, there is shown, for the sake of clarity, a schematic illustration of the 3-D topography of the same slider as in FIG. 3, showing more clearly the relative heights of the ABS elements and their vertical extent. What is generally called the ABS plane of the slider ((300) in FIG. 2) is the intersection of an imaginary plane with the highest structural surfaces of the slider 3-D topography.

Referring again to FIG. 3, the trailing edge of the slider is indicated by an arrow as (100) and the leading edge, which is not specifically shown, would be approximately at (200). The ABS of the slider is divided into two separated portions, a trailing ABS portion and a leading ABS portion. The leading ABS portion of the slider is denoted as (250) and the trailing edge portion is denoted as (150). The trailing edge portion includes two parallel side rails (325) and a central rail (350). These structures are separated from each other by deep airflow channels (320) that help provide a stable aerodynamic performance of the slider. The vertically “highest” surfaces as given by the planar perspective (height being measured in the direction towards the disk surface) of these structures form the ABS plane of the slider and are represented by a denser shading. The depth of the airflow channels (320) will be denoted dc and they are unshaded to indicate that they are the deepest structures in the figure.

The magnetic sensor (30), shown as a short line, and adjacent but below-surface heating DFH element (not shown) are both embedded within a micro-pad (310) formed at the trailing edge of the central rail (350). The micro-pad is shown with a somewhat trapezoidal shape, but the shape may be arbitrary. The lateral edges of the trailing edge of the central rail project outward (in a direction towards the trailing edge) in the form of two wings (355), substantially symmetrically placed about a center line of the central rail, which two wings substantially surround the micro-pad (310). As can be seen in the figure, the extension and shape of the wings produces a concavity within the trailing edge perimeter of the central rail. The micro-pad fits within this concavity and has a lateral dimension (measured along the trailing edge) denoted as lₘₚ and a width dimension, denoted as wₘₚ, (measured from trailing towards leading edge) and is laterally surrounded by the wings.

A trench (360) of width dimension denoted wₜ separates the micro-pad from the wings and the remainder of the concave perimeter and, therefore, the micro-pad is physically isolated from the central rail. As we shall discuss below, the depth of the trench (360), denoted dₜ, is a strong determining factor in the properties of the design and the resulting dynamic performance of the slider can be significantly and advantageously tuned by adjusting (varying) that depth. This depth is independently controlled within the manufacturing process and it is neither defined by nor restricted by the depth of other features, such as the airflow channels (320). In the slider of the present figure, the micro-pad width wₘₚ (as measured from trailing edge to leading edge) is preferably between approximately 30 and 60 microns and the width of the trench wₜ (similarly measured) is preferably approximately 20 microns. The depth of the trench dₜ is preferably between approximately 0.3 and 3 microns. It is also seen that the central rail has additional topological features, such as shallow grooves and higher barriers, that produce a desirable airflow past the micro-pad during slider operation. Although the shapes and dimensions of these shallow grooves can be adjusted to optimize aerodynamic characteristics, it is the micro-pad and trench that produce the performance that satisfies the objects of the invention.

By embedding the heater element and the read/write head in this small micro-pad and separating it from the rest of the slider by the trench, the air pressure on the sensor area is maintained in a stable manner during HDD operation. This is because the air pressure on the sensor area depends on the incoming airflow and the “pressure length,” which is the distance the air travels along the sensor area. In addition, as noted above, the topological shape of the central rail behind (i.e., to the leading edge side) the micro-pad also divides the air flow and limits the amount of air that passes through the micro pad.

As discussed above, the preferred embodiment of the present invention is a slider ABS design that provides excellent DFH efficiency, eliminates severe air pressure variations across the sensor region and produces a carefully regulated variation of flying height as a function of power supplied to the DFH heater. In a traditional prior art ABS design without the separated micro-pad, the measured air pressure at the sensor element can be as high as 23 atm. The present ABS design as illustrated in FIG. 2 and FIG. 3 produces a measured air pressure in that same region of only 5 atm. This provides excellent DFH efficiency for the air-bearing properties of the slider because the pushback of the air pressure has been significantly reduced. In addition, the reduction of air pressure along the ABS of the present invention, particularly in the sensor region, insures that flying height will be only minimally affected by surface warpage and other surface variations of the rotating disk and that excellent DFH efficiency during read/write operations will be assured.

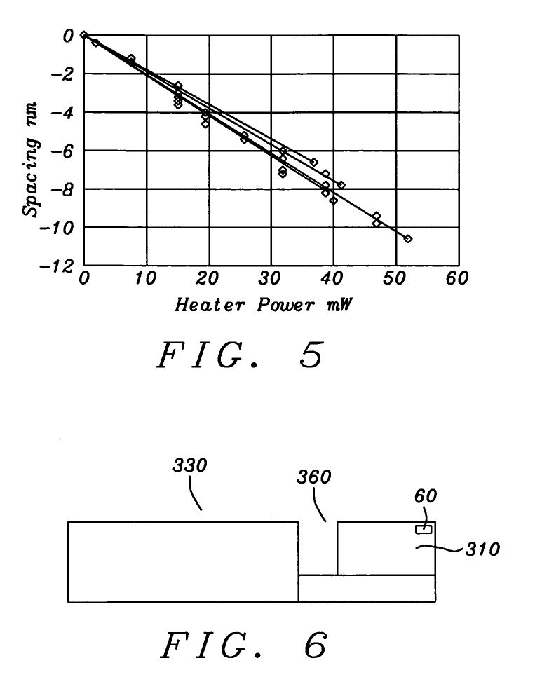

Referring to FIG. 4, there is shown a graphical representation of the measured flying height spacing (vertical axis) of several prior art sliders of similar design as a function of power supplied to the heater. This design shows that a power of 100 mW generally produces a spacing of 9 nm. Referring to FIG. 5, there is shown a similar graph for several samples of the slider of the present invention, where the DFH efficiency is nearly doubled, as indicated by a spacing of 19 nm for a power input of 100 mW. The sliders in FIG. 5 all have a trench depth of approximately 1.5 microns and efficiencies of approximately 19 nm/100 mW. The differences between them is only in their flying heights.

### Second Preferred Embodiment

The second preferred embodiment of this invention is a method of controlling the DFH protrusion of the micro-pad surface for a given heater power and, therefore, of controlling the protrusion of the area surrounding and including the active surfaces of the read/write head. This method is to vary the depth of the trench surrounding the micro-pad. In the discussion above, we indicated that the role of the trench was to render the micro-pad separate from the trailing edge portion of the ABS and thereby to reduce the pressure on the micro-pad surface by reducing the pressure length. In the present embodiment, we demonstrate that the trench provides an additional control mechanism for the slider dynamics as a result of the ability to vary its depth.

Referring to highly schematic FIG. 6, there can be seen a vertical cross-section of the micro-pad (310), the adjustable trench (360), the heater element (60) and a portion of the central rail (330).

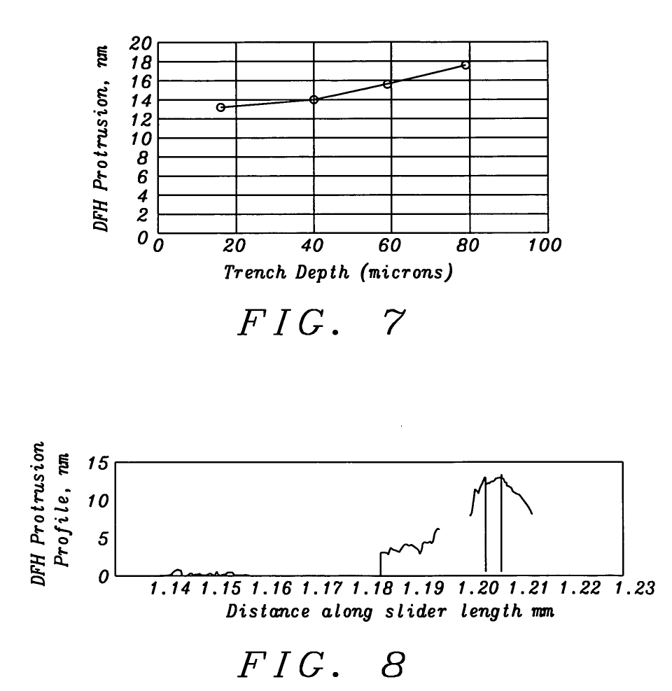

Referring to FIG. 7, there is shown a graphical representation of DFH protrusion as a function of trench depth for a fixed power to the heater of 85 mW. As can be seen, as the trench depth is changed from approximately 20 microns to approximately 80 microns, the micro-pad protrusion varies smoothly from approximately 14 nm to approximately 18 nm. It can be seen that the slider of this invention, given the ability to control the depth of the trench, can be made to produce a micro-pad protrusion of as much as 21 nm/100 mW, whereas the prior art sliders can produce no more than 13 nm/100 mW.

Referring to FIG. 8, there is shown a graphical display of an exemplary micro-pad protrusion profile (in nm.) measured as a function of distance (in mm.) along a cross-sectional cut, for a heater power of 85 mW. The two vertical lines indicate positions of upper and lower shields surrounding the active portions of the read/write head. The region of no protrusion corresponds to the trench location.

As is understood by a person skilled in the art, the preferred embodiments of the present invention are illustrative of the present invention rather than being limiting of the present invention. Revisions and modifications may be made to methods, processes, materials, structures, and dimensions through which is formed a DFH type slider having increased and controlled DFH efficiency and minimal flying height variations during HDD operation, while still providing such a DFH type slider, formed in accord with the present invention as defined by the appended claims.

1. A DFH slider having increased and controllable DFH efficiency and reduced sensitivity of its operational flying height to disk surface irregularities and environmental conditions, said slider comprising:
an ABS topology, including separated leading and trailing portions, wherein
said trailing portion further includes a pair of laterally disposed parallel side rails, a topologically patterned center rail formed substantially midway between said side rails and parallel to said side rails and airflow channels formed between said center rail and said side rails; wherein
a trailing edge of said center rail includes a pair of laterally disposed wing-like projections symmetrically disposed about a center line of said central rail, thereby forming a concavity within a trailing edge perimeter of said center rail and wherein
a micro-pad is formed within said concavity, said micro-pad having a width dimension, Wₘₚ and a lateral dimension lₘₚ and said micro-pad being surrounded laterally by said wing-like projections and said micro-pad being separated from said central rail trailing edge perimeter by a trench having a width wₜ and an independently variable depth dₜ, whereby said micro-pad forms a completely isolated portion of said trailing edge having a small surface area and wherein
a read/write head and DFH heating element is embedded within said micro-pad, whereby said heater is capable of providing a thermally induced protrusion of said micro-pad with a diminished pushback effect.

2. The slider of claim 1 wherein said micro-pad provides a short pressure length and a corresponding reduced pressure at said read/write head, thereby diminishing a heater-induced pushback effect during slider operation.

3. The slider of claim 1 wherein the topological patterning of said center rail divides an airflow around said micro-pad, thereby further diminishing said pushback effect and providing aerodynamic stability during slider operation.

4. The slider of claim 2 wherein said reduced pressure and reduced pushback allows a greater reduction of flying height for a given heater power level, thereby lowering power consumption and lengthening the lifetime of the read/write head.

5. The slider of claim 2 wherein reduced pressure and reduced pushback renders the slider less sensitive to flying height variations caused by variations in a disk surface.

6. The slider of claim 1 wherein said trench depth, dₜ, is varied to provide a desired range of micro-pad protrusions as a function of heater power.

7. The slider of claim 6 wherein a micro-pad protrusion of between approximately 13 nm and 21 nm at a heater power of approximately 100 mW can be obtained by varying said trench depth between approximately 0.3 microns and 3 microns.

8. The slider of claim 1 wherein the lateral dimension, lₘₚ, and width dimension, wₘₚ, of said micro-pad are each between approximately 30 and 60 microns.

9. The slider of claim 1 wherein the width dimension of the trench, wₜ, is approximately 20 microns.

10. The slider of claim 1 wherein the lateral dimension, lₘₚ, and width dimension, wₘₚ, of said micro-pad are each between approximately 30 and 60 microns and wherein the width dimension of the trench, wₜ, is approximately 20 microns and whereby varying the trench depth, dₜ, between approximately 20 microns and 80 microns at a heater power of approximately 85 mW produces a variation in flying height between approximately 14 nm and 18 nm.

11. The slider of claim 1 wherein said DFH efficiency is approximately 19 nm/100 mW for a trench depth of approximately 1.5 microns.

12. The slider of claim 11 wherein an air pressure at the position of said read/write head is approximately 5 atm.
